(19) United States
(12) Patent Application Publication
(10) Pub. No.: US 2026/0153324 A1
(43) Pub. Date: Jun. 4, 2026

(54) PARALLEL OPTICAL COHERENCE TOMOGRAPHY SYSTEM USING AN INTEGRATED PHOTONIC DEVICE

(71) Applicant: Washington University, St. Louis, MO (US)

(72) Inventor: Chao Zhou, St. Louis, MO (US)

(21) Appl. No.: 18/719,105

(22) PCT Filed: Dec. 13, 2022
(86) PCT No.: PCT/US2022/081462

§ 371 Date: Jun. 12, 2024

Related U.S. Application Data
(60) Provisional application No. 63/288,822, filed on Dec. 13, 2021.

(51) Int. Cl. G01B 9/02; G01B 9/02015; G01B 9/02017; G01B 9/02091

(52) U.S. Cl. CPC G01B 9/02051; G01B 9/02019; G01B 9/02027; G01B 9/02091

(57) ABSTRACT

Integrated photonic chips and related systems and methods suitable for parallel optical coherence tomography scanning are disclosed that include multiplexed data detection and transmission to a single channel of a DAC or parallel data detection and transmission to separate channels of a multi-channel DAC.

### CROSS-REFERENCE TO RELATED APPLICATIONS

This application claims priority from U.S. Provisional Application Ser. No. 63/288,822 filed on Dec. 13, 2022, the content of which is incorporated herein by reference in its entirety.

### STATEMENT REGARDING FEDERALLY SPONSORED RESEARCH OR DEVELOPMENT

This invention was made with government support under EB025209 awarded by the National Institutes of Health. The government has certain rights in the invention.

### MATERIAL INCORPORATED-BY-REFERENCE

Not applicable.

### FIELD OF THE DISCLOSURE

The present disclosure generally relates to systems, devices, and methods for performing parallel optical coherence tomography (SDM-OCT) imaging of biological tissues.

### BACKGROUND OF THE DISCLOSURE

Optical coherence tomography (OCT) is an emerging biomedical imaging technology that enables micron-scale, cross-sectional, and three-dimensional (3D) imaging of biological tissues non-invasively. OCT functions as a type of “optical biopsy,” imaging tissue microstructure with resolutions approaching that of standard histopathology by microscopy, but without the need to remove and process tissue specimens.

OCT is analogous to ultrasound imaging, except that light instead of sound is used in OCT to provide 10 to 100 times better resolution compared to ultrasound. To date, OCT has been used in a wide range of clinical applications in humans, including ophthalmology, cardiology, endoscopy, urology, dermatology, and dentistry. OCT has been widely used in ophthalmic clinics as a standard diagnostic tool for diabetic retinopathy, macular degeneration, glaucoma, and other retinal and corneal diseases.

Improving imaging speed is a main driving force for the development of optical coherence tomography (OCT). Space-division multiplexing optical coherence tomography (SDM-OCT) is a recently developed parallel OCT imaging method used to achieve multi-fold speed improvement. However, the assembly of multiple fiber optics components conventionally used in such systems may be labor-intensive and susceptible to errors which makes it challenging for mass production. In addition, the numerous components of an OCT system consume space and are not readily amenable for incorporation into a compact imaging device which may be used in various medical diagnostic settings or for other uses. Improvements in SDM-OCT systems are desired.

Other objects and features of the disclosure will be in part apparent and in part pointed out hereinafter.

### DESCRIPTION OF THE DRAWINGS

Those of skill in the art will understand that the drawings, described below, are for illustrative purposes only. The drawings are not intended to limit the scope of the present teachings in any way.

FIG. 1 is a schematic diagram illustrating an arrangement of the elements of a fiber-based parallel OCT imaging system in which elements within the red dashed-line box may be integrated into a photonic chip are enclosed within a red dashed-line box.

FIG. 2 is a schematic diagram illustrating a photonic chip-based parallel OCT imaging system.

FIG. 3 is a schematic diagram illustrating the elements of a photonic chip for a parallel OCT imaging system that includes a single waveguide input from an external light source.

FIG. 4 is a schematic diagram illustrating the elements of a photonic chip that includes input from an external light source and input and output from an external reference arm.

FIG. 5 is a schematic diagram illustrating the elements of a photonic chip for a parallel OCT imaging system that includes a single waveguide input from an external light source and Fabry-Perot Bragg Gratings (FPBGs) integrated into both the OCT and MZI circuits.

FIG. 6 is a schematic diagram illustrating the elements of a photonic chip for a parallel OCT imaging system that includes an external light source, an external reference arm, and Fabry-Perot Bragg Gratings (FPBGs) integrated into both the OCT and MZI circuits.

FIG. 7 is a schematic diagram illustrating the elements of a photonic chip for a parallel OCT imaging system that includes a single waveguide input from an external light source, Fabry-Perot Bragg Gratings integrated into both the OCT and MZI circuits, and an array of balanced photodetectors integrated on the photonic device as active components in order to detect interference signals from parallel OCT imaging channels, in which bandpass filters and signal mixing/combining circuits are integrated before the OCT signal is acquired by the data acquisition card.

FIG. 8 is a schematic diagram illustrating the elements of a photonic chip for a parallel OCT imaging system that includes an external light source, an external reference arm, Fabry-Perot Bragg Gratings integrated into both the OCT and MZI circuits, and an array of balanced photodetectors integrated on the photonic device as active components in order to detect interference signals from parallel OCT imaging channels, in which bandpass filters and signal mixing/combining circuits are integrated before the OCT signal is acquired by the data acquisition card.

FIG. 9 is a schematic diagram illustrating the elements of a photonic chip for a parallel OCT imaging system that includes a single waveguide input from an external light source, Fabry-Perot Bragg Gratings integrated into both the OCT and MZI circuits, and an array of balanced photodetectors integrated on the photonic device as active components in order to detect interference signals from parallel OCT imaging channels.

FIG. 10 is a schematic diagram illustrating the elements of a photonic chip for a parallel OCT imaging system that includes an external light source, an external reference arm, Fabry-Perot Bragg Gratings integrated into both the OCT and MZI circuits, and an array of balanced photodetectors integrated on the photonic device as active components in order to detect interference signals from parallel OCT imaging channels.

There are shown in the drawings arrangements that are presently discussed, it being understood, however, that the present embodiments are not limited to the precise arrangements and are instrumentalities shown. While multiple embodiments are disclosed, still other embodiments of the present disclosure will become apparent to those skilled in the art from the following detailed description, which shows and describes illustrative aspects of the disclosure. As will be realized, the invention is capable of modifications in various aspects, all without departing from the spirit and scope of the present disclosure. Accordingly, the drawings and detailed description are to be regarded as illustrative in nature and not restrictive.

### DETAILED DESCRIPTION OF THE DISCLOSURE

In various aspects, devices, systems, and methods are disclosed that achieve significant improvements in optical coherence tomography (OCT) imaging speed and reduce the footprint of the system by using integrated photonics. Parallel OCT imaging is performed by illuminating multiple sample locations simultaneously and detecting interference signals simultaneously. In various aspects, photonic integrated circuit (PIC) techniques were used to design and fabricate passive and active optoelectronic circuits on the same chip.

The resulting photonic chips incorporate a variety of enhancements relative to existing photonic chip designs to provide additional functionality. Existing photonic chip designs are described in U.S. Pat. Nos. 9,400,169, 10,107,616, and 11,079,214, the content of each of which is incorporated by reference in its entirety. In some aspects, the photonic chip includes an integrated Mach-Zender interferometer (MZI) to provide accurate phase calibration of the OCT image signal. In other aspects, the photonic chip includes Fabry-Perot Bragg Gratings (FPBGs) integrated into both the OCT and MZI circuits to allow registration of the OCT and MZI signals. In additional aspects, the photonic chip includes at least two Fabry-Perot Bragg Gratings in either the OCT or MZI channel to minimize the phase jitter generated by the laser source. In other additional aspects, the photonic chip includes an array of balanced photodetectors integrated into the photonic device as active components to detect interference signals from parallel OCT imaging channels. In yet other additional aspects, the photonic chip includes bandpass filters and signal mixing/combining circuits configured to condition and combine the interference signals from parallel OCT imaging channels detected by an array of balanced photodetectors for acquisition by a data acquisition card. In various aspects, OCT systems that include the disclosed photonic chips in various aspects can significantly reduce the footprint and cost of OCT systems while improving the performance of the OCT systems.

### Parallel OCT Imaging Systems and Methods

In various aspects, the disclosed photonic chips provide for parallel imaging beams to enhance OCT imaging speed while maintaining imaging resolution and sensitivity. In various aspects, the parallel optical coherence tomography (SDM-OCT) system according to the present disclosure splits an imaging beam on the sample arm in order to illuminate multiple physical locations on the sample simultaneously. In some embodiments, a single sample arm may be used. Each beam is optically delayed by the SDM-OCT system so that when images are formed, signals from different physical locations are detected in different frequency bands (i.e. imaging depth). Advantageously, this allows parallel detection of signals from multiple imaging points and therefore improves OCT imaging speed dramatically and preserves system resolution and sensitivity. In various aspects, the SDM-OCT system may utilize commercially available light sources.

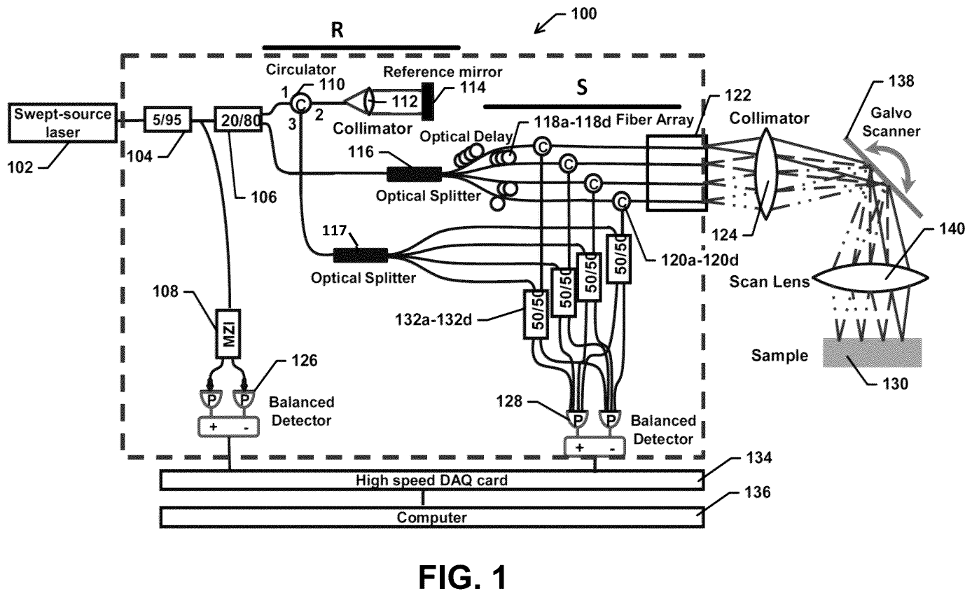

FIG. 1 is a diagram showing a non-limiting exemplary embodiment of an SDM-OCT system 100 utilizing a wavelength-tunable light source (e.g. swept-source laser). The SDM-OCT system 100 may generally include the swept-source laser 102 or other light source, a first optical device 104 such as an optical coupler including, but not limited to, a 5/95 optical coupler, a second optical device 106 such as a 20/80 optical coupler, a reference arm R defining a first optical light path (i.e. reference channel), a sample arm S defining a second optical light path (i.e. sampling channel), and other components as further described herein. The reference arm R provides an optical path of predetermined fixed length for generating a reference signal for comparison with reflected light signals returned from the object or sample under examination via the sample arm S, as further described herein.

In some embodiments, the light source 102 may be a wavelength-tunable, long-coherence light source to provide optimal imaging depth range. In one embodiment, without limitation, the coherence length may be greater than 5 mm to achieve a proper imaging range for the SDM-OCT system 100. A commercially-available vertical-cavity surface-emitting laser (VCSEL) diode, such as for example without limitation Thorlabs Inc., SL1310V1 with a center wavelength of ˜1310 nm, may be used as the light source for SDM-OCT system 100. Other suitable center wavelengths may be used. In one embodiment, the VCSEL laser may have a sweep rate of ˜100 kHz, a tuning range of ˜100 nm, and a coherence length of over 50 mm. The output of the laser from light source 102 may be ˜37 mW. VCSEL diodes are essentially semiconductor-based devices that emit light perpendicular to the chip surface. It will be appreciated that other suitable light source specifications for VCSEL diodes and/or other types of light sources may be used. For example, a Fourier domain mode-lock (FDML) laser, or a MEMS tunable laser, such as from Axsun Technologies, Inc., Santec Corporation, Exalos Inc., or Insight Photonics Inc., etc. may be used.

Referring again to FIG. 1, the light beam output from the light source 102 is optically coupled to the optical coupler 104 for dividing or splitting the single input light into two output light beams. An optical coupler (aka splitter) is generally a passive optical fiber device operable to couple and distribute light from one or more input fibers to one or more output fibers. Accordingly, optical energy input is split into multiple output signals retaining essentially the same properties as the input light. Suitable optical couplers include optical fiber couplers available from AC Photonics, Inc., Thorlabs, Inc., or other suppliers.

As illustrated in FIG. 1, the 5/95 coupler 104 is configured to produce a 5/95 optical split, where 5% of the light is diverted to a Mach-Zehnder interferometer (MZI) 108, while the remaining 95% of the light is used to implement SDM-OCT imaging as described below to implement phase calibration of the OCT signal. In various aspects, any suitable means of implementing phase calibration of the OCT signal may be used in the SDM-OCT system 100 without limitation, including, but not limited to, MZIs. Any known suitable MZI may be incorporated into the SDM-OCT system 100 without limitation. The MZI signal produced by the MZI is acquired by a balanced detector 126 and used for phase calibration of the OCT signal in one embodiment. In other possible embodiments, the MZI signal may be omitted if an optical clock signal is used instead to clock the acquisition of the OCT signal. In various aspects, the implementation of phase calibration of the OCT signal is not limited to either of the arrangements described above. If an optical clock is used, it will be understood that the 5/95 optical coupler 104 may be omitted.

In various aspects, any suitable optical division or splitting of input light beams identified as a percentage of the incident beam may be used in the SDM-OCT systems without limitation, depending on the intended application and system parameters. Accordingly, the invention is expressly not limited to those light division or split percentages disclosed herein which represent merely some of many possible designs that might be used for the couplers. It will be appreciated by those skilled in the art that the determination of the optical split ratio depends on how much light is intended to be directed into each of the sample and reference arms. It is desirable to have as much power as possible on the sample while keeping the power on the sample to be within a safe limit. In the meantime, sufficient power is needed on the reference arm to get shot-noise limited sensitivity.

Referring again to FIG. 1, the 95% portion of the light from the 5/95 optical splitter 104 is transmitted to a 20/80 optical splitter 106. In this embodiment, the 20/80 optical splitter directs 20% of the input light to the reference arm R (reference channel) and 80% of the light to the sample arm S (detection channel). In other embodiments, a 10/90 optical splitter may be used, where 10% of the input light is directed to the reference arm R (reference channel) and 90% of the light is directed to the sample arm S (detection channel).

In the reference arm R, the input light to the reference arm enters a circulator 110. In various aspects, optical circulators are three-port fiber optic devices used to separate optical signals which travel in the opposite direction in an optical fiber. Light that enters one of the ports (including reflected light traveling in an opposite direction than the incident light) exits the next port. As illustrated in FIG. 1, input light entering port 1 of the optical circulator 110 is directed out of port 2 into a collimator lens 112 and the collimated beam is reflected by a reference mirror 114. The reflected reference beam passes back into port 2 of the circulator 110 via the collimator lens 112 and exits the circulator 110 at port 3. Light exiting port 3 of the circulator 110 is split into multiple reference beams by an optical splitter 117. Each of the multiple reference beams is directed into corresponding 50/50 optical couplers 132a, 132b, 132c, 132d to be combined with the multiple sampling beams to produce interference signals as described herein.

Referring again to FIG. 1, the light directed into the sample arm from the 20/80 beam splitter 106 is split into multiple sampling beams by an optical splitter 116. Each of the sampling beams passes through a corresponding optical delay 118a, 118b, 118c, and 118d and into port 1 of optical circulators 120a, 120b, 120c, and 120d. The optical circulators 120a, 120b, 120c, and 120d direct the sampling beams into a fiber array 122 via respective ports 2.

The sampling beams pass through the fiber array 122 to be collimated by a collimator 124 and focused using a scan lens 140 onto multiple different spots or sampling locations across the surface of sample 130.

Optical splitter 116, which in one embodiment may be an optical fiber splitting device, may divide the sampling beam into at least two or more sampling beams at the output from the device. In one exemplary embodiment, without limitation, the sample arm light beam may be split by a 1×8 optical splitter and transmitted into eight different optical fibers forming the optical fiber array 122 for sampling. Each optical fiber in the sampling fiber array 122 represents a sample location S1, S2, S3, . . . Sn on the sample or specimen, where n=sample location number. In FIG. 1, it should be noted that only four optical fibers are shown for simplicity and clarity.

It should be noted that an optical splitter 116 may be used that divides or splits the incident sampling light into more or less than eight output optical fibers depending on the intended sampling application, the number of sample locations desired, and other factors. Similarly, an optical splitter 117 may be used that divides or splits the incident reference light into more or less than eight output optical fibers depending on the intended sampling application, the number of sample locations desired, and other factors. Accordingly, the invention is not limited to any particular number of sampling or reference optical fibers in the sampling fiber array 122 or the number of sampling locations (S₁ . . . Sₙ). In various aspects, the optical splitter 116 and 177 divides or splits incident light into 2, 4, 8, 16, 32, 64, 128, 256, or more beams. Numerous variations and configurations are possible.

Referring again to FIG. 1, sample 130 can be scanned simultaneously by the sampling light from the fiber array 122 using a galvanometer scanning mirror 138. The sampling light from the fiber array may be focused into parallel sampling beams using any suitable optical elements without limitation including, but not limited to, a collimator lens 124 positioned between the fiber array 122 and the galvanometer scanning mirror 138, and a scan lens positioned between the galvanometer scanning mirror 138 and the sample 130, as illustrated in FIG. 1. The galvanometer scanning mirror 138 includes a galvo motor with an angled vibrating/oscillating (e.g. up and down) mirror driven by a motor shaft (not illustrated). Sampling light beams from the fiber array 122 are independently transmitted and scanned across a surface of sample 130 by galvanometer scanning mirror 138, thereby producing discrete and independent illuminated sampling spots or locations each corresponding to one of the output ports. The scanning mirror 138 may project the sampling beams onto the sample in any suitable pattern to capture the desired image information. Other variations and types of scanning devices may be used without limitation. In some non-limiting examples, the scanning mirror 138 may be Cambridge Technologies, Model 6215H, or Thorlabs, GVS102.

Referring again to FIG. 1, reflected sample light signals returned simultaneously from each sampling location of sample 130 are routed via the scan lens 140, scanning mirror 138, collimator lens 124, and fiber array 122 to the second ports of optical circulators 120a, 120b, 120c, and 120d. Optical circulators 120a, 120b, 120c, and 120d direct the reflected sampling beams to corresponding 50/50 optical couplers 132a, 132b, 132c, and 132d to be combined with the multiple reference beams from optical splitter 117 to produce interference signals.

The reflected interference signals from both the OCT via couplers 132a, 132b, 132c, and 132d and the interference signal generated by MZI 108 are detected by dual balanced detectors 128 and 126, respectively (e.g. PDB480C-AC, 1.6 GHz, Thorlabs Inc.) and their outputs are acquired simultaneously by a dual-channel high-speed data acquisition card 134 (e.g. ATS 9373, Alazar Technologies Inc.). The acquired signal data from data acquisition card 134 is streamed continuously to the memory of computer 136 or memory accessible to another suitable processor-based device or PLC (programmable logic controller) through a suitably configured port. The signal data may be stored on the memory for further processing, display, export, etc.

The “computer” 136 as described herein is representative of any appropriate computer or server device with a central processing unit (CPU), microprocessor, micro-controller, or computational data processing device or circuit configured for executing computer program instructions (e.g. code) and processing the acquired signal data from data acquisition card 134. This may include, for example without limitation, desktop computers, personal computers, laptops, notebooks, tablets, and other processor-based devices having suitable processing power and speed. Computer 136 may include all the usual appurtenances associated with such a device, including without limitation the properly programmed processor, a memory device(s), a power supply, a video card, visual display device or screen (e.g. graphical user interface), firmware, software, user input devices (e.g., a keyboard, mouse, touch screen, etc.), wired and/or wireless output devices, wired and/or wireless communication devices (e.g. Ethernet, Wi-Fi, Bluetooth, etc.) for transmitting captured sampling images. Accordingly, the invention is not limited by any particular type of processor-based device.

The memory may be any suitable non-transitory computer-readable medium such as, without limitation, any suitable volatile or non-volatile memory including random access memory (RAM) and various types thereof, read-only memory (ROM) and various types thereof, USB flash memory, and magnetic or optical data storage devices (e.g. internal/external hard disks, floppy discs, magnetic tape CD-ROM, DVD-ROM, optical disk, ZIP™ drive, Blu-ray disk, and others), which may be written to and/or read by a processor operably connected to the medium.

It will further be appreciated that various aspects of the present embodiment may be implemented in software, hardware, firmware, or combinations thereof. The computer programs described herein are not limited to any particular embodiment and may be implemented in an operating system, application program, foreground or background process, driver, or any combination thereof, executing on a single computer or server processor or multiple computer or server processors.

It should be noted that the optical light paths and optical coupling between components shown in the figures and described herein may be made by any suitable means including for example, without limitation, optical cables or fibers, relays, open-space transmission (e.g. air or other medium without physical contact between components), other light-transmitting technologies presently available or to be developed, and any combination thereof. Accordingly, the invention is not limited to any particular optical coupling means and numerous variations are possible. In one embodiment, optical fibers may be used for optically coupling components other than lenses, mirrors, and/or the object or sample of interest.

### SDM-OCT Photonic Chips

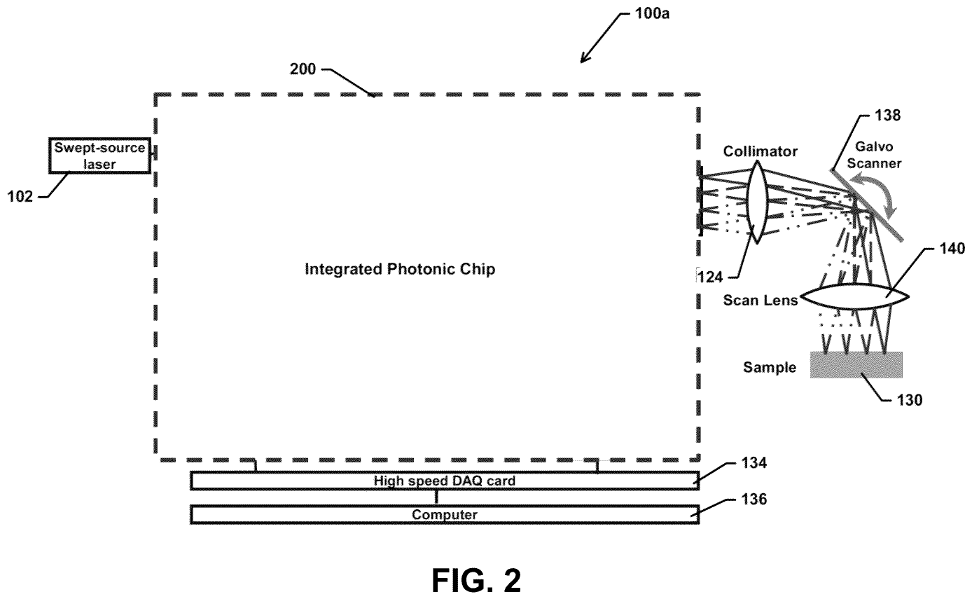

In various aspects, at least a portion of the elements of the SDM-OCT system 100, or functional equivalents thereof, are replaced by a photonic chip. FIG. 2 is an illustration of a photonic chip-based SDM-OCT system 100a in one aspect that includes a swept-source laser 102 or other light source optically coupled to an integrated photonic chip 200 configured to perform at least a portion of the tasks associated with parallel SDM-OCT imaging as described herein. In addition, the integrated photonic chip 200 is operatively coupled to a series of optical elements arranged to direct and/or scan one or more sampling beams to and from sample 130 as described above. As illustrated in FIG. 2, the series of optical elements may include a collimating lens 124, a scanning mirror 138, and a scan lens 140 in one aspect. The integrated photonic chip may further be operatively coupled to a high-speed data acquisition card 134 and computer 136 to receive and store detected interference signals based on reference and sampling beams, as well as an integrated MZI (not illustrated).

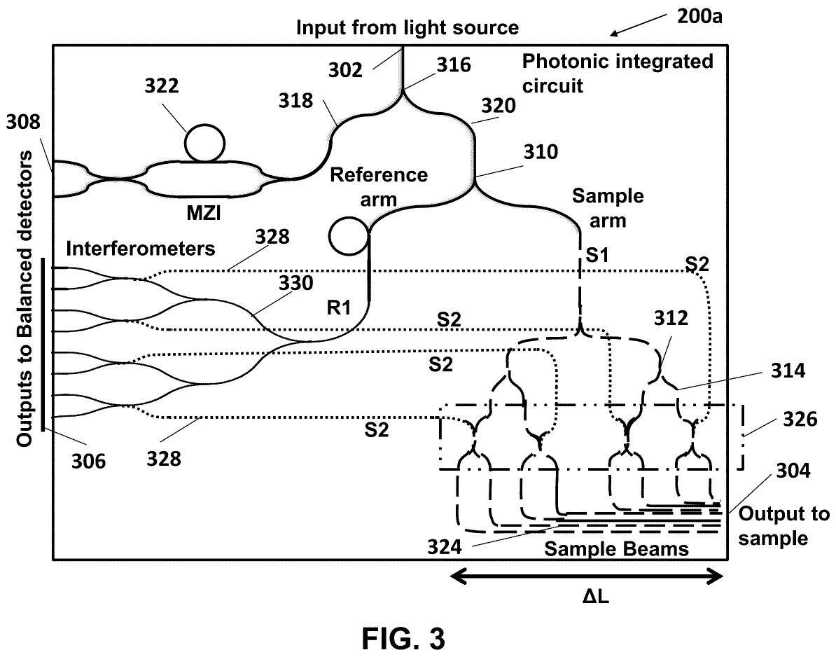

A schematic layout of a silicon-based photonic chip 200a in one aspect is shown in FIG. 3. The photonic chip 200a comprises a substrate that may have a generally rectangular prismatic or cuboid configuration in one embodiment including two opposing parallel major surfaces defining a thickness T measured therebetween and four perpendicular side surfaces defining a perimeter of the chip. The substrate is formed of a material having a suitable refractive index. In some aspects, the substrate may have a thickness of about 1-2 mm. Other thicknesses, however, may be used for the substrate without limitation. In various other aspects, the substrate may have a thickness of 0.25 mm- 0.75 mm, 0.5 mm- 1 mm, 0.75 mm- 1.25 mm, 1 mm- 1.5 mm, 1.25 mm- 1.75 mm, 1.5 mm- 2 mm, 1.75 mm- 2.25 mm, 2 mm- 2.5 mm, 2.25 mm- 2.75 mm, and 2.5 mm- 3 mm.

The substrate of the photonic chip 200a may be made of any suitable single material or multi-layered composite combination of materials conventionally used for constructing a photonic chip with waveguides without limitation. Non-limiting examples of suitable materials suitable for the construction of the photonic chip 200a include indium phosphide (InP), lithium niobate (LiNbO₃), silicon nitride (Si3N₄), gallium arsenide (GaAs), silicon, and silicon-on-insulator (SOI). In one exemplary aspect, the substrate of the photonic chip 200a comprises silicon nitride.

By way of another non-limiting example, the photonic chip 200a may be constructed of an SOI substrate. SOI chips typically comprise a silicon (Si) base layer, an intermediate silicon dioxide (SiO₂) insulator layer, and a thin top crystalline silicon layer typically with a thickness less than the insulator layer. The top silicon layer, which guides the light beams or waves, has a refractive index n=3.45 and the SiO₂ insulator layer has a refractive index n=1.45.

Referring again to FIG. 3, the photonic chip 200a is patterned with a waveguide structure having an array or plurality of interconnected branched waveguides including, but not limited to, branched on-chip waveguide channels 314 splitting the sample signal S1 into multiple channels, waveguide channels 324 to direct the sample signals to and from the sample, and waveguide channels 328 to direct reflected light signals S2 from the sample to interferometers for detection, as described in additional detail below. In various aspects, the waveguides may be configured to act as waveguide channels, wherein the waveguide channels are configured to create on-chip photonic beam splitters and optical time delay units or regions. The waveguide channels direct and guide the incident beam on-chip 200a to propagate and follow the optical light paths as indicated in the figure through the chip, thereby advantageously allowing channels of different lengths to be created in the time delay region which produce an optical delay between the channels for a parallel OCT system.

The patterned waveguide channels may be formed in the substrate of the chip 200a using any known conventional semiconductor fabrication techniques or methods known in the art without limitation. In one exemplary non-limiting example, waveguide channels may be formed by doping the substrate in a manner well-known and used in the art for the fabrication of semiconductors. Doping may involve processes such as diffusion or ion implantation to introduce a dopant element to select areas of the silicon substrate to create the desired pattern of waveguide channels. The doped channels have a first refractive index that is different than the base silicon material refractive index, thereby causing the light signals or wave to follow the doped channel pattern. Other semiconductor fabrication techniques beyond those noted above used in silicon photonics however may be used in other embodiments without limitation.

Another non-limiting example of a suitable semiconductor method that may be used to form the patterned waveguide channels is a combination of photolithography or deep UV (ultraviolet) lithography to define the desired waveguide channel pattern followed by selectively etching the Si top layer in the case of an SOI chip to form the waveguides. The comparatively large difference in the refractive indices noted above between the SiO₂ insulator layer (n=1.45) and Si top layer (n=3.45) as noted above confines the electromagnetic field into the top Si layer causing the electromagnetic light signals or waves in the optical spectrum to travel within the confines of waveguide channels in the photonic chip 200a.

Referring again to FIG. 3, the chip 200a includes an input port 302 formed on a first one of the side surfaces which directly couples to an input optical fiber operatively coupled to a light source. The chip 200a further includes a plurality of sampling beam ports 304 formed on another side surface. In various other embodiments, the input and sampling beam ports 302,304 may be formed on any two different side surfaces of the photonic chip 200a depending on the locations of these ports desired for the scanning device.

Referring again to FIG. 3, the chip 200a further includes detector ports 306 formed on a third side surface of the chip 200a that directly couple the interference signals from interferometers to a balanced detector array (not illustrated) positioned external to the chip 200a. The chip 200a further includes MZI ports 308 formed on a side surface of the chip 200a that directly couple the interference signals from the on-chip MZI to a balanced detector array (not illustrated) positioned external to the chip 200a.

In various aspects, the sides of the chip 200a selected for the input port 302, sampling beam ports 304, detector ports 306, and MZI ports 308 may vary and are dependent upon the efficient use of chip space to minimize the size of the chip and/or to optimize the arrangement for the physical instrument or equipment in which the chip will be integrated. Accordingly, the arrangement does not limit the invention and the illustrated embodiment represents one of many possible configurations possible.

Referring again to FIG. 3, the input light is split by splitter 316 into an MZI branch 318 and an OCT branch 320. The MZI branch 318 provides input light to an on-chip MZI 322 used to provide accurate phase calibration of the OCT image signal as described above. The light provided via the OCT branch 320 is split by splitter 310 to direct portions into a reference arm and a sample arm. The sample arm delivers a sampling beam S1 as input light to on-chip splitters and time delays formed by specially configuring the multiple branched waveguide structure created using the waveguide channels. In some aspects, splitter 310 is a 50:50 splitter that directs equal portions of the light provided via the OCT branch 320 to the reference arm and sample arm. In other aspects, the splitter 310 may direct a larger or smaller portion of the light provided via the OCT branch 320 to the reference arm relative to the portion directed to the sample arm. In various other aspects, the splitter 310 may be a 5:95 splitter, a 10:90 splitter, a 15:85 splitter, a 20:80 splitter, a 25:75 splitter, a 30:70 splitter, a 35:65 splitter, a 40:60 splitter, a 45:55 splitter, a 50:50 splitter, a 55:45 splitter, a 60:40 splitter, a 65:35 splitter, a 70:30 splitter, a 75:25 splitter, an 80:20 splitter, an 85:15 splitter, a 90:10 splitter, or a 95:5 splitter.

As illustrated in FIG. 3, two rows of 1×2 photonic waveguide splitters 312 formed by multiple branched on-chip waveguide channels 314 are used to evenly and gradually split the incident sampling light S1 in each row from the initial singular beam or channel into the final 8 sample beams or channels. Each waveguide splitter is formed by a branch in the waveguide which divides the input sampling beam S1 equally (i.e. 50/50) into two output sampling light beams. This dividing of light beams occurs successively in each of the 3 rows of waveguide splitters for convenience to create the 8 output sampling beams as illustrated in FIG. 3. In various other embodiments, the photonic chip 200a may include a lesser or greater number of rows including, but not limited to, a single splitter row (e.g. 1×8 splitter in this example) used to split the sampling light S1 into the desired number of sampling beams for scanning the sample. The number of rows of splitters used does not limit the invention and may be dictated in some embodiments by the geometry and/or size of the photonic chip 200a desired for the given application. It further bears noting that more or less than eight sampling beams or channels may be used in other embodiments as needed and the invention is expressly not limited to the eight beam prototype embodiment described herein. In various aspects, the row or rows of splitters may divide or split incident light into 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49. 50, 51, 52, 53, 54, 55, 56, 57, 58, 59, 60, 61, 62, 63, 64, 128, 256, or more sample beams.

Each sampling beam transmits in separate waveguide channels 324 through the chip 200a, forming the plurality of output beams or channels emitted from photonic chip 200a through the plurality of sampling beam ports 304 clustered together on one side of the chip's substrate, as shown in FIG. 3. Optical delays between each of the 8 waveguide channels 324 are created in the photonic chip 200a by setting different terminal path or channel lengths for each channel between the third row of photonic splitters in the three-row cascade and the sampling beam ports 304, with a physical length (optical delay) difference ΔL. The time or optical delays created by varying the lengths of the waveguide channels 324 generate multiplexed interference signals as described above. In various embodiments, the difference ΔL is selected to produce an optical delay shorter than the coherence length of the light source between the plurality of sampling beams so that when images are formed, signals from different physical locations are detected in different frequency bands.

In various other aspects, the photonic chip may incorporate multiple detection channels, wherein the DAC or other device used to detect and record OCT signals may include multiple channels, wherein each OCT signal is directed to a dedicated channel selected from the multiple channels of the DAC or other data acquisition device. Without being limited to any particular theory, the use of multiple detection channels obviates the need for differences in optical path length or optical delays for each channel used to encode each channel within a multiplexed signal directed to a single channel of a DAC or other data acquisition device. Consequently, the optical path lengths of each OCT channel may be matched or may vary between one another in a known pattern or randomly without impact on the operation of the photonic chip using multichannel detection.

In some aspects, a uniform or equal difference in length ΔL between adjacent waveguide channels 324 may be provided for transmitting sampling light of all wavelengths in different bands. In other aspects, the delay need not be uniform. For some applications, as an example, the system designer may intentionally use non-uniform delays to accommodate a specific sample geometry to be scanned for example where the sample has a non-uniform and/or non-planar surface geometry in order to optimize the scanned images returned from the sample. The invention is therefore not limited to a uniform difference in length ΔL between each adjacent waveguide channel 324.

Referring again to FIG. 3, the three-row cascading 1×2 splitters 312 (one input, two outputs) are arranged to split and guide the sampling light S1 beam in a first direction (downward as shown in FIG. 3). In some aspects, the terminal portions of the waveguide channels 324 are associated with each output port in the time delay region of the chip, the waveguides having different predetermined lengths to create optical time delays between the sampling beams or channels.

In various aspects, the terminal portions of the waveguide channels 324 may follow any direction or path relative to other waveguides on the chip without limitation. In some aspects, the terminal portions of the waveguide channels 324 are arranged generally perpendicularly to the waveguide channels 314 in the foregoing splitter region, as illustrated in FIG. 3. In other aspects, the incident sampling light S1 following the waveguide channel path in the time delay region travels and progresses generally perpendicularly to the sampling light path in the splitter region which advantageously conserves space on the chip 200a to minimize its size, thereby allowing the creation of an extremely small photonic splitter and time delay unit. The term “generally” is used to connote that the sampling light S1 in the splitter region does not necessarily travel perfectly perpendicular to the sampling light in the time delay region when propagating through the curved and angled portions of the individual photonic splitters 312, but rather the general flow of the sampling light through these regions is perpendicular to each other in this non-limiting embodiment. In other embodiments, the flow of sampling light may be obliquely angled or parallel relative to each other in the splitter and time delay regions. Accordingly, the invention is not limited to the flow of sampling light through chip 200a as illustrated in FIG. 3.

It will be appreciated that in other embodiments besides the foregoing prototype, different numbers of waveguide channels, length or delay differences between channels, output spacing, polish angles, chip dimensions, and configurations of waveguides may be used.

Further, the splitters formed by waveguide channels may split incoming beams in any suitable proportion ranging from about 5:95 to 95:5. In various other aspects, the splitters formed by waveguide channels may split incoming beams in proportions of 5:95, 10:90, 15:95, 20:95, 25:95, 30:95, 35:95, 40:95, 45:95, 50:95, 55:95, 60:95, 65:95, 70:95, 75:95, 80:95, 5:95, 5:95, 95:5, Accordingly, the invention is expressly not limited to the above design and recited values of these parameters in the prototype demonstration system. Other embodiments may therefore be different in these aspects and are not limiting of the invention.

Typically, when light is split from 1 fiber to N sampling channels using a photonic chip 200a as described above, the intensity for each of the sampling channels is about 1/N of the input intensity. This allows the even distribution of the light through all the output channels of the photonic chip for sampling. If the reflected sampling light was collected and returned from the sample by passing back through the three-row photonic splitter cascade in the reverse direction, only about 1/N of the sampling beam intensity is returned to produce OCT signals as described above. This insertion loss is proportional to how many channels the photonic chip 101 splits the light.

To reduce insertion losses for the reflected sampling beams S2, the sampling beams S1 are split only on the first pass through the photonic chip 200a to the sample. Back-reflected light returned from the sample reduces the number of on-chip optical splitters the light passes through, resulting in much lower losses. Referring again to FIG. 3, reflected light signals S2 returned from the sample during the sampling process used to produce the digitized images of the sample do not pass through the two rows of photonic splitters 312, but instead only pass through one row of 2×2 couplers or splitters 326 (two inputs, one output) shown in the rectangular box. The reflected sampling beams S2 are routed via dedicated waveguide channels 328 (shown as dotted lines in FIG. 3) to interfere with reference light R1 from the reference arm at an array of interferometers. With this arrangement, the top two rows of optical couplers or splitters 312 (each row produces 3 dB loss) are bypassed to avoid light loss.

Referring again to FIG. 3, an interferometer region is patterned on the chip 200a that receives reference light signals R1 each of which interferes with a reflected light signal S2 received from the sampling splitter region that collects the reflected light returned from the sample. The incident single reference light signal R1 is divided into the four reference light signals R1 by patterning the reflected light waveguide channels 328 with the appropriate number of branches as shown in FIG. 3. In one embodiment, all the reference light R1 waveguide channels may have the same optical path length whereas the sampling light waveguide channels 324 have different optical path lengths to produce the optical time delays.

In other embodiments, all sampling light S1 waveguide channels may have the same optical path length while each of the reference light R1 waveguide channels 330 have different optical path lengths analogous to the above-mentioned optical delays between sampling light S1 waveguide channels. In various other aspects, a combination of sample arm and reference arm waveguide layout design may be used to generate the same differential optical path length delay between different interference signals originating from different imaging channels. The optical path length difference is used to shift the frequency of the interference signal from different imaging channels into different frequency bands, which correspond to different depth ranges in the acquired OCT image. Accordingly, the invention is not limited to necessarily having the same optical path lengths for either the sample arm or the reference arm. The interference signals from different channels are formed into different frequency bands when the optical path length difference between individual sample arms and reference arms is unique. Since all the interference signals are in different frequency bands, a single photodetector may be used to detect all the signals at once simultaneously in parallel.

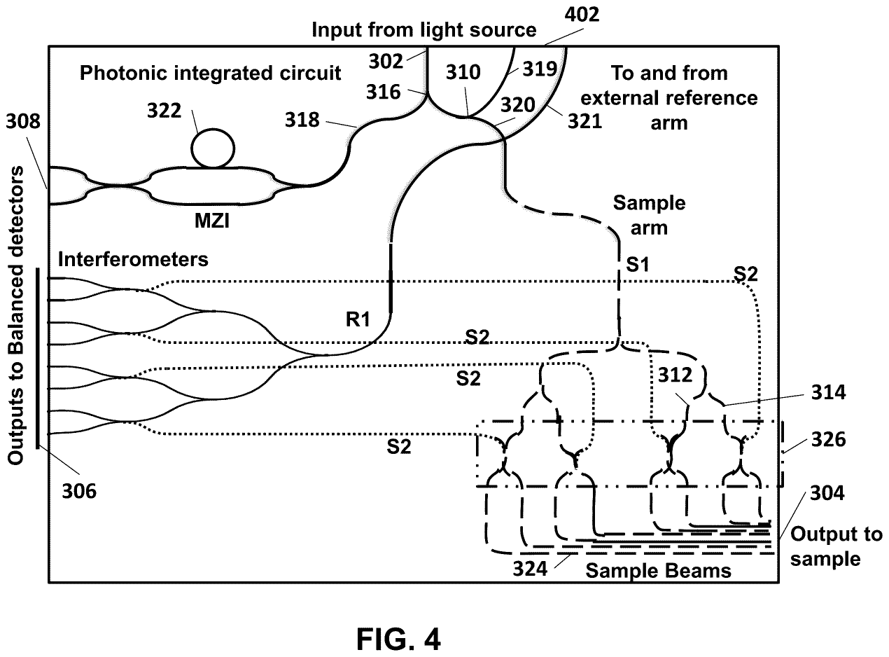

FIG. 4 is a schematic illustration of a photonic chip 200b in another aspect. The arrangement of elements of the photonic chip 200b illustrated in FIG. 4 is substantially similar to the photonic chip 200a illustrated in FIG. 3 with respect to the input port 302, sampling beam ports 304, detector ports 306, and MZI ports 308, as well as the arrangement of light guides and splitters for the sample arm, interferometer array, and MZI 322. In various aspects, the photonic chip 200b further includes one or more reference arm ports 402 configured to direct light to an external/free space reference arm (not illustrated) via waveguide 319 and from the external/free space reference arm via waveguide 321. In various aspects, the external reference arm may include a collimator and reflector similar to those illustrated in FIG. 1 (see collimator 112 and reference mirror 114) and described above. In other aspects, the external reference arm may include additional optical elements including, but not limited to, optic splitters, delays, and any other optical element suitable for a reference arm without limitation. In some aspects, the external reference arm comprising free space optics may be used to implement dispersion matching with the sample arm.

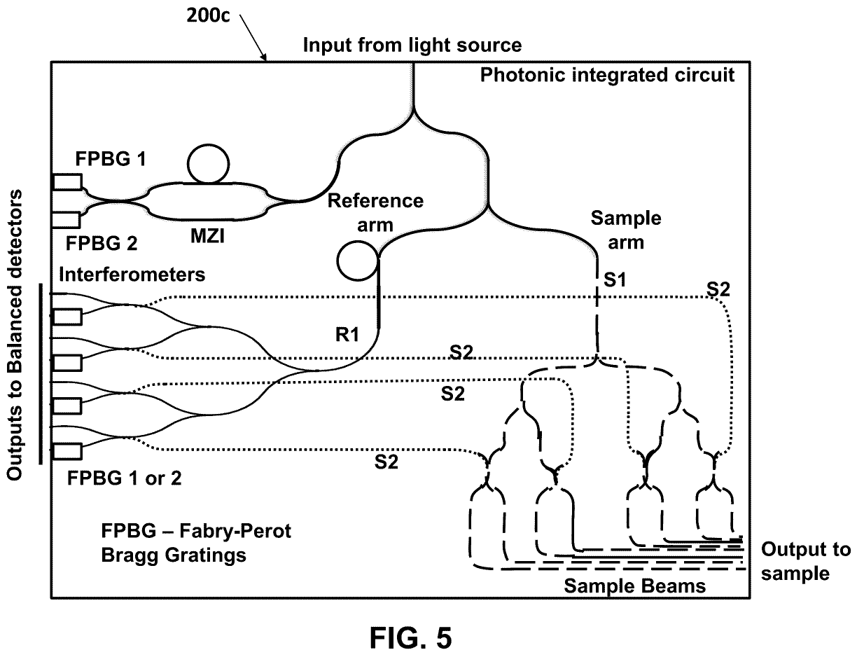

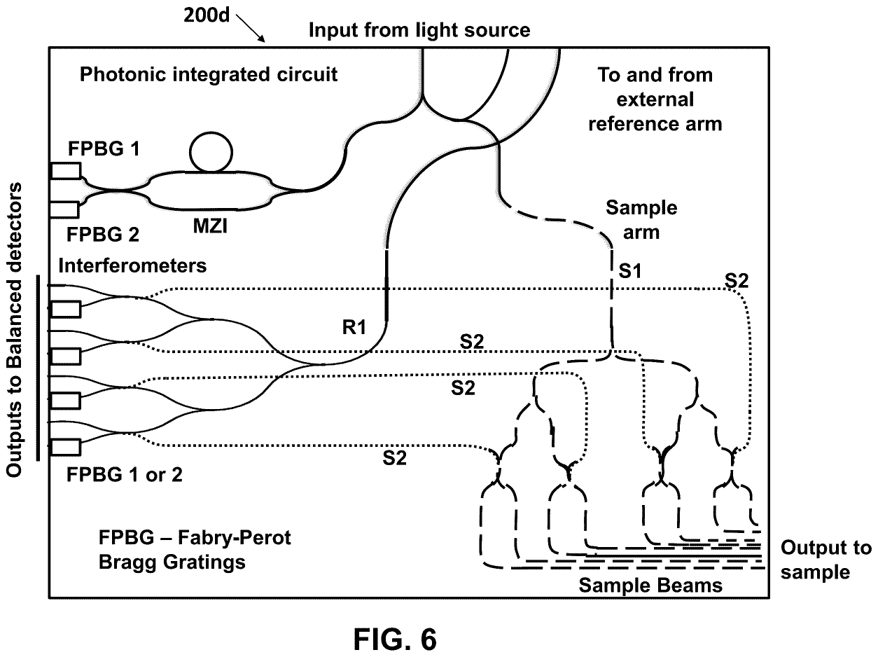

FIG. 5 is a schematic illustration of a photonic chip 200c in an additional aspect. The arrangement of elements of the photonic chip 200c illustrated in FIG. 5 is substantially similar to the photonic chip 200a illustrated in FIG. 3 with additional Fabry-Perot Bragg Gratings (FPBGs) integrated into both the OCT (interferometer array) and MZI circuits. In some aspects, the FPBGs provide for the registration of the OCT and MZI signals. In another aspect, at least two Fabry-Perot Bragg Gratings may be integrated into either the OCT or MZI channel to minimize the phase jitter generated by the laser source. FIG. 6 is a schematic illustration of a photonic chip 200d that is substantially similar to the photonic chip 200c of FIG. 5, with an added external/free space reference arm similar to the external reference arm illustrated in the photonic chip 200b of FIG. 4.

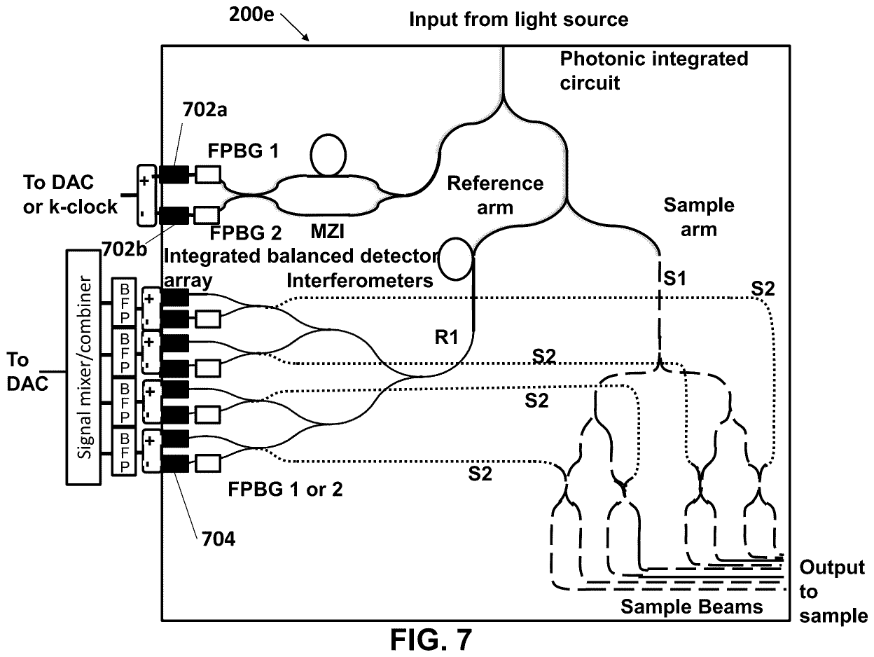

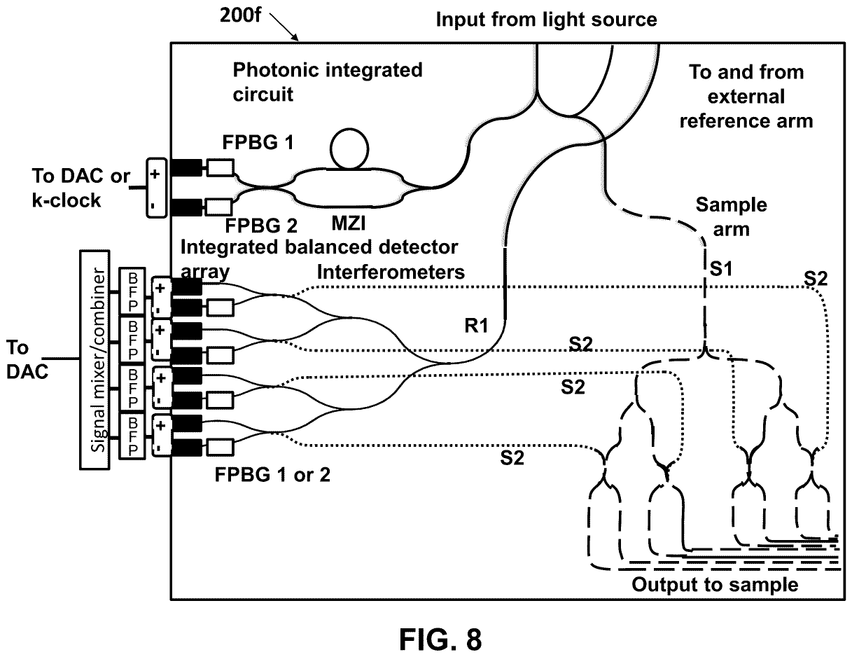

FIG. 7 is a schematic illustration of a photonic chip 200e in an additional aspect. The arrangement of elements of the photonic chip 200e illustrated in FIG. 7 is substantially similar to the photonic chip 200c illustrated in FIG. 5 with an additional on-chip photodetectors 702a and 702b operatively coupled to the outputs of the MZI arm and an additional on-chip photodetector array 704 operatively coupled to the outputs of the interferometer array. All photodetectors are shown as black boxes in FIG. 7. As illustrated in FIG. 7, the photodetectors 702a and 702b operatively coupled to the MZI arm are operatively coupled to a DAC or k-clock to facilitate accurate phase calibration of the OCT image signal. The photodetector array 704 operatively coupled to the outputs of the interferometer array is configured to detect OCT-related interference signals. As illustrated in FIG. 7, the signals detected by the photodetector array 7004 may be conditioned by bandpass filters (BPFs) and mixed with a signal mixer/combiner prior to passing to a DAC for subsequent multiplexed data acquisition and recording as described above. FIG. 8 is a schematic illustration of a photonic chip 200f in an additional aspect that is substantially similar to the photonic chip 200e of FIG. 7, with an added external reference arm similar to the external reference arm of the photonic chip 200d of FIG. 6.

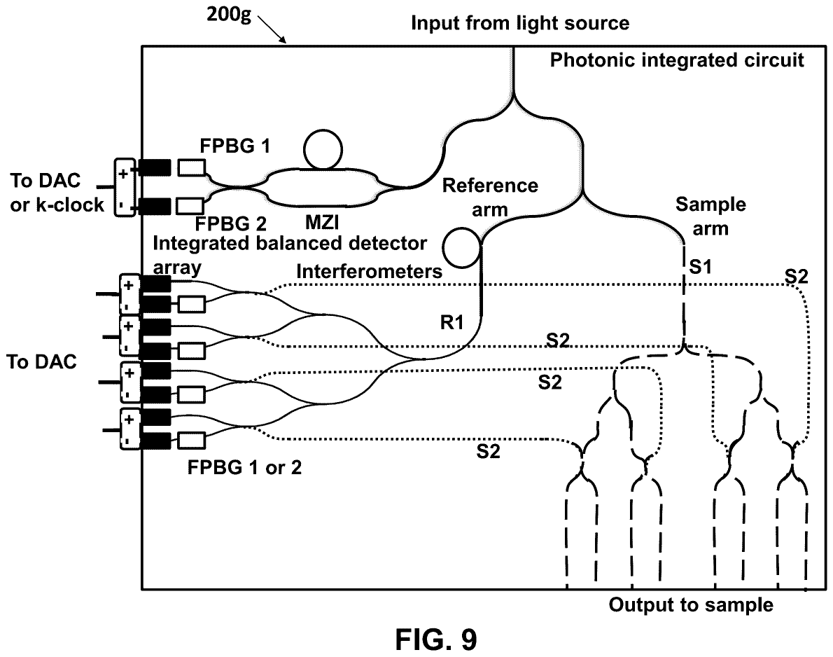

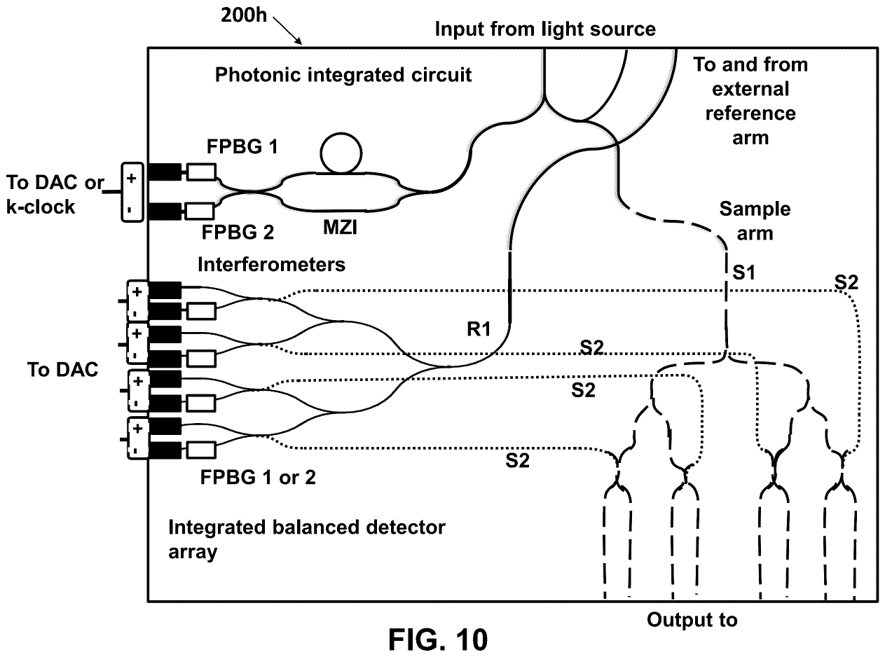

FIG. 9 is a schematic illustration of a photonic chip 200g in an additional aspect. The arrangement of elements of the photonic chip 200g illustrated in FIG. 9 is substantially similar to the photonic chip 200e illustrated in FIG. 7 but has eliminated the bandpass filters and signal mixer/conditioner used to condition OCT signals prior to recording using a single multiplexed DAC channel. Instead, the OCT signals are sent to separate dedicated channels of the DAC, obviating the multiplexing of OCT signals and associated elements of the photonic chip used to implement the multiplexed OCT signals. It is to be noted that the separate DAC channels used to separately record OCT signals do not record optical delays of the OCT signals used by the previously described systems of FIGS. 1, 2, 3, 4, 5, 6, 7, and 8 for multiplexed transmission of OCT signals to a single DAC channel. FIG. 10 is a schematic illustration of a photonic chip 200h in an additional aspect that is substantially similar to the photonic chip 200g of FIG. 9, with an added external reference arm similar to the external reference arm of the photonic chip 200b of FIG. 4.

Without being limited to any particular theory, the capture and storage of each OCT signal stream on individual dedicated DAC channels further obviate the need for providing variations in optical path length/optical delays for each OCT channel as described above. In various aspects, photonic chips 200g and 200h that include OCT signal acquisition using multichannel DAC are compatible with OCT channels with relatively matched optical path lengths or with OCT channels with different optical path lengths, since each OCT channel is captured and stored individually in parallel.

Definitions and methods described herein are provided to better define the present disclosure and to guide those of ordinary skill in the art in the practice of the present disclosure. Unless otherwise noted, terms are to be understood according to conventional usage by those of ordinary skill in the relevant art.

In some embodiments, numbers expressing quantities of ingredients, properties such as molecular weight, reaction conditions, and so forth, used to describe and claim certain embodiments of the present disclosure are to be understood as being modified in some instances by the term “about.” In some embodiments, the term “about” is used to indicate that a value includes the standard deviation of the mean for the device or method being employed to determine the value. In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable. The numerical values presented in some embodiments of the present disclosure may contain certain errors necessarily resulting from the standard deviation found in their respective testing measurements. The recitation of ranges of values herein is merely intended to serve as a shorthand method of referring individually to each separate value falling within the range. Unless otherwise indicated herein, each individual value is incorporated into the specification as if it were individually recited herein. The recitation of discrete values is understood to include ranges between each value.

In some embodiments, the terms “a” and “an” and “the” and similar references used in the context of describing a particular embodiment (especially in the context of certain of the following claims) can be construed to cover both the singular and the plural, unless specifically noted otherwise. In some embodiments, the term “or” as used herein, including the claims, is used to mean “and/or” unless explicitly indicated to refer to alternatives only or the alternatives are mutually exclusive.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

Any publications, patents, patent applications, and other references cited in this application are incorporated herein by reference in their entirety for all purposes to the same extent as if each individual publication, patent, patent application, or other reference was specifically and individually indicated to be incorporated by reference in its entirety for all purposes. Citation of a reference herein shall not be construed as an admission that such is prior art to the present disclosure.

Having described the present disclosure in detail, it will be apparent that modifications, variations, and equivalent embodiments are possible without departing the scope of the present disclosure defined in the appended claims. Furthermore, it should be appreciated that all examples in the present disclosure are provided as non-limiting examples.

1-8. (canceled)

9. An integrated photonic chip for parallel optical coherence tomography (OCT) scanning, the photonic chip comprising:
an optical input port configured to receive a singular input beam from a light source;
a plurality of optical output ports configured to transmit a plurality of sampling beams from the chip to a sample and to receive a plurality of reflected sampling beams from the sample;
a first branched waveguide structure comprising a Mach-Zehnder interferometer (MZI) arm, a reference arm, and a sampling arm, the first branched waveguide configured to divide the incident singular beam into an MZI input beam transmitted by the MZI arm, a reference input beam transmitted by the reference arm, and a sampling input beam transmitted by the sampling arm;
an MZI waveguide structure configured to receive the MZI input beam and to generate MZI interference signals indicative of a phase of the input beam;
a multiple branched waveguide structure comprising a plurality of interconnected waveguide channels formed in a substrate of the photonic chip, the waveguide channels defining a splitter region configured to optically couple sampling input beam of the sample arm to each of the output ports and an interferometer region configured to define a plurality of photonic interferometers, wherein the photonic interferometers are arranged to receive a reference light and a plurality of reflected light signals returned from the sample, the photonic interferometers being configured and operable to combine the reflected light signals with the reference light to produce a plurality of OCT interference signals which are emitted to an array of OCT output ports;
a pair of MZI output ports operatively coupled to the MZI waveguide structure, the MZI port configured to deliver the MZI interference signals to at least one balanced detector; and
the array of OCT output ports operatively coupled to the photonic interferometers, the array of OCT output ports configured to deliver the OCT interference signals to an array of balanced detectors.

10. The chip of claim 9, further comprising a pair of MZI Fabry-Perot Bragg gratings (FPBGs) integrated into each output of the pair of MZI output ports, the pair of FPBGs configured to minimize phase jitter generated by the external light source.

11. The chip of claim 9, further comprising a plurality of interferometer FPBGs integrated into one output of each photonic interferometer of the plurality of photonic interferometers, the plurality of interferometer FPBGs configured to register the OCT interference signals from different photonic interferometers.

12. The chip of claim 9, wherein the at least one balanced detector comprises at least one internal balanced detector or at least one external balanced detector.

13. The chip of claim 9, further comprising a pair of reference arm input/output ports, the pair of reference arm input/output ports operatively coupled to an external reference arm, the external reference arm configured to generate the reference input beam.

14. The chip of claim 9, further comprising a first balanced photodetector integrated between the MZI waveguide structure and the MZI output ports.

15. The chip of claim 9, further comprising an array of balanced photodetectors integrated between the plurality of photonic interferometers and the array of OCT output ports.

16. The chip of claim 15, wherein each balanced photodetector of the array of balanced photodetectors is configured to direct a stream of detected OCT interference signals to one channel of a multi-channel DAC, wherein each channel of the multi-channel DAC is configured to receive one stream of detected OCT interference signal from one balanced photodetector of the array of balanced photodetectors.

17. The chip of claim 16, further comprising an array of bandpass filters operatively coupled to the array of balanced photodetectors.

18. The chip of claim 17, further comprising a signal mixer operatively coupled to the array of bandpass filters, the signal mixer configured to combine filtered signal streams from the array of bandpass filters into a single multiplexed signal stream for transfer to a single channel of the multi-channel DAC.

19. An integrated photonic chip for parallel optical coherence tomography (OCT) scanning, the photonic chip comprising:
an optical input port configured to receive a singular input beam from a light source;
a plurality of optical output ports configured to transmit a plurality of sampling beams from the chip to a sample and to receive a plurality of reflected sampling beams from the sample;
a first branched waveguide structure comprising a reference arm and a sampling arm, the first branched waveguide configured to divide the incident singular beam into a reference input beam transmitted by the reference arm and a sampling input beam transmitted by the sampling arm;
a multiple branched waveguide structure comprising a plurality of interconnected waveguide channels formed in a substrate of the photonic chip, the waveguide channels defining a splitter region configured to optically couple sampling input beam of the sample arm to each of the output ports and an interferometer region configured to define a plurality of photonic interferometers, wherein the photonic interferometers are arranged to receive a reference light and a plurality of reflected light signals returned from the sample, the photonic interferometers being configured and operable to combine the reflected light signals with the reference light to produce a plurality of OCT interference signals which are emitted to an array of OCT output ports;
the array of OCT output ports operatively coupled to the photonic interferometers, the array of OCT output ports configured to deliver the OCT interference signals to an array of balanced detectors; and
an array of balanced photodetectors integrated between the plurality of photonic interferometers and the array of OCT output ports.

20. The chip of claim 19, wherein each balanced photodetector of the array of balanced photodetectors is configured to direct a stream of detected OCT interference signals to one channel of a multi-channel DAC, wherein each channel of the multi-channel DAC is configured to receive one stream of detected OCT interference signal from one balanced photodetector of the array of balanced photodetectors.

21. The chip of claim 20, further comprising an array of bandpass filters operatively coupled to the array of balanced photodetectors.

22. The chip of claim 21, further comprising a signal mixer operatively coupled to the array of bandpass filters, the signal mixer configured to combine filtered signal streams from the array of bandpass filters into a single multiplexed signal stream for transfer to a single channel of the multi-channel DAC.

23. The chip of claim 19, wherein the first branched waveguide structure further comprises a Mach-Zehnder interferometer (MZI) arm and the first branched waveguide is further configured to divide the incident singular beam into an MZI input beam transmitted by the MZI arm.

24. The chip of claim 23, further comprising an MZI waveguide structure configured to receive the MZI input beam and to generate MZI interference signals indicative of a phase of the input beam.

25. The chip of claim 24, further comprising a pair of MZI output ports operatively coupled to the MZI waveguide structure.

26. The chip of claim 25, further comprising a first balanced photodetector integrated between the MZI waveguide structure and the MZI output ports, wherein the MZI ports are configured to deliver the MZI interference signals to the first balanced detector.

27. The chip of claim 25, further comprising a pair of MZI Fabry-Perot Bragg gratings (FPBGs) integrated into each output of the pair of MZI output ports, the pair of FPBGs configured to minimize phase jitter generated by the external light source.

28. The chip of claim 19, further comprising a plurality of interferometer FPBGs integrated into one output of each photonic interferometer of the plurality of photonic interferometers, the plurality of interferometer FPBGs configured to register the OCT interference signals from different photonic interferometers.
